(19) United States
(12) Patent Application Publication
(10) Pub. No.: US 2025/0028084 A1
(43) Pub. Date: Jan. 23, 2025

(54) ANTI-REFLECTIVE FILM-ATTACHED TRANSPARENT SUBSTRATE AND IMAGE DISPLAY DEVICE

(71) Applicant: AGC Inc., Tokyo (JP)

(72) Inventors: Kazuya TAKEMOTO, Tokyo (JP); Keisuke KAWAI, Tokyo (JP); Teruo FUJIWARA, Tokyo (JP); Hideaki TAKAHOSHI, Tokyo (JP)

(73) Assignee: AGC Inc., Tokyo (JP)

(21) Appl. No.: 18/908,125

(22) Filed: Oct. 7, 2024

Related U.S. Application Data
(63) Continuation of application No. PCT/JP2023/014148, filed on Apr. 5, 2023.

(30) Foreign Application Priority Data
Apr. 8, 2022 (JP) 2022-064752

(51) Int. Cl. G02B 1/115; G02B 5/02

(52) U.S. Cl. CPC G02B 1/115; G02B 5/0278

(57) ABSTRACT

An anti-reflective film-attached transparent substrate includes: a transparent substrate comprising two main surfaces; and a diffusion layer and an anti-reflective film in this order from a transparent substrate side on one main surface of the transparent substrate. When reflection on the other main surface of the transparent substrate is eliminated and a light source is incident on the one main surface at an incident angle of 45°, a* and b* of diffusely reflected lights at angles of −15°, 15°, 25°, 45°, 75°, and 110° with respect to a specularly reflected light under a D65 light source satisfy formulas (1) −6≤a*≤2, (2) −1≤b*≤12 (3) b*≤−2a*+4, and (4) b*≥−2a*−5.

### CROSS-REFERENCE TO RELATED APPLICATIONS

This is a bypass continuation of International Application No. PCT/JP2023/014148 filed on Apr. 5, 2023, and claims priority from Japanese Patent Application No. 2022-064752 filed on Apr. 8, 2022, the entire content of which is incorporated herein by reference.

### TECHNICAL FIELD

The present invention relates to an anti-reflective film-attached transparent substrate and an image display device including the same.

### BACKGROUND ART

In recent years, a method of installing a transparent substrate such as a cover glass on a front surface of an image display device such as a liquid crystal display (LCD) has been used from the viewpoint of aesthetic appearance. In order to prevent glare from an external light on such a transparent substrate, a transparent substrate provided with an anti-reflective film (hereinafter, also referred to as an anti-reflective film-attached transparent substrate) is known. For example, Patent Literature 1 discloses an anti-reflective film-attached transparent substrate, which has a light absorption ability and an insulating property.

In addition, in order to prevent the glare from the external light, it is also known to provide a diffusion layer on the transparent substrate. The diffusion layer diffuses the incident light to prevent the glare from the external light. However, in the case where the transparent substrate includes a diffusion layer and is used in an image display device, the screen may appear whitish due to the diffused light when turned off. Therefore, when the anti-reflective film as described above is further provided on the diffusion layer, reflection of the incident light can be prevented and the whiteness can be reduced. Accordingly, it is possible to suitably prevent the glare while improving a black texture when the screen is turned off.

μ-LED displays using a μ-LED element as a light source have been attracting attention as an image display device in recent years. Among them, a large μ-LED display is produced by coupling (tiling), for example, about 200 small LED panels of about A5 size (148 mm×210 mm) with no gaps therebetween.

### CITATION LIST

### Patent Literature

Patent Literature 1: JP2018-115105A

### SUMMARY OF INVENTION

### Technical Problem

Since the anti-reflective film disclosed in Patent Literature 1 utilizes optical interference, an optical path length changes depending on an incident angle and an emission angle of the light, which may result in various changes in reflection color (color tone). In particular, in the case where the anti-reflective film is provided on the diffusion layer, when the diffusion layer makes it easier for the light to be diffusely reflected, a change in color tone depending on the angle tends to be relatively remarkable. In addition, when tiling a plurality of LED panels, such as in the case of producing a large μ-LED display, once diffusion reflection colors (the color tones of diffusely reflected lights) of the panels are different, the appearance, particularly during turning-off, has a variety of colors, which may greatly reduce the quality.

Therefore, an object of the present invention is to provide an anti-reflective film-attached transparent substrate that makes a color deviation less noticeable even after tiling and an image display device including the same.

### Solution to Problem

The inventors of the present invention have experimentally found that, when a* and b* of diffusely reflected lights at various angles satisfy predetermined requirements when a light is incident on an anti-reflective film-attached transparent substrate at a predetermined angle, it is possible to obtain an anti-reflective film-attached transparent substrate that makes a color deviation less noticeable even after tiling. Thus, the present invention has been completed.

That is, the present invention relates to the following 1 to 13.

1. An anti-reflective film-attached transparent substrate including:
a transparent substrate having two main surfaces; and
a diffusion layer and an anti-reflective film in this order from a transparent substrate side on one main surface of the transparent substrate, in which
when reflection on the other main surface of the transparent substrate is eliminated and a light source is incident on the one main surface at an incident angle of 45°, a* and b* of diffusely reflected lights at angles of −15°, 15°, 25°, 45°, 75°, and 110° with respect to a specularly reflected light under a D65 light source satisfy the following formulas (1) to (4).

$$- 6 \leq {a}^{*} \leq 2 \qquad ( 1 )$$

$$- 1 \leq {b}^{*} \leq 12 \qquad ( 2 )$$

$${b}^{*} \leq - 2 {a}^{*} + 4 \qquad ( 3 )$$

$${b}^{*} \geq - 2 {a}^{*} - 5 \qquad ( 4 )$$

2. The anti-reflective film-attached transparent substrate according to the above 1, having a haze value of 30% or more.

3. The anti-reflective film-attached transparent substrate according to the above 1 or 2, in which L* of the diffusely reflected light at −15° is 30 to 60, L* of the diffusely reflected light at 15° is 15 to 35, and L* of the diffusely reflected light at 25° is 5 to 20 under a D65 light source.

4. The anti-reflective film-attached transparent substrate according to the above 1 or 2, having a luminous transmittance (Y) of 20% to 90%.

5. The anti-reflective film-attached transparent substrate according to the above 1 or 2, in which the anti-reflective film has a sheet resistance of 10⁴Ω/□ or more.

6. The anti-reflective film-attached transparent substrate according to the above 1 or 2, in which b* of a transmission color under a D65 light source is 5 or less.

7. The anti-reflective film-attached transparent substrate according to the above 1 or 2, in which the anti-reflective film has a laminated structure in which at least two dielectric layers having different refractive indices are laminated, at least one of the dielectric layers is mainly formed of a Si oxide, at least another layer among layers in the laminated structure is mainly formed of a mixed oxide of an oxide containing at least one selected from the group A consisting of Mo and W and an oxide containing at least one selected from the group B consisting of Si, Nb, Ti, Zr, Ta, Al, Sn, and In, and a content of elements of the group B contained in the mixed oxide is 65 mass % or less with respect to a total of elements of the group A contained in the mixed oxide and the elements of the group B contained in the mixed oxide.

8. The anti-reflective film-attached transparent substrate according to the above 1 or 2, further including an antifouling film on the anti-reflective film.

9. The anti-reflective film-attached transparent substrate according to the above 1 or 2, in which the transparent substrate includes a glass.

10. The anti-reflective film-attached transparent substrate according to the above 1 or 2, in which the transparent substrate includes at least one resin selected from polyethylene terephthalate, a polycarbonate, acrylic, silicone, and triacetyl cellulose.

11. The anti-reflective film-attached transparent substrate according to the above 1 or 2, in which the transparent substrate is a laminate including a glass and at least one resin selected from polyethylene terephthalate, a polycarbonate, acrylic, silicone, and triacetyl cellulose.

12. The anti-reflective film-attached transparent substrate according to the above 11, in which the glass is chemically strengthened.

13. An image display device including the anti-reflective film-attached transparent substrate according to the above 1 or 2.

### Advantageous Effects of Invention

According to one aspect of the present invention, it is possible to provide an anti-reflective film-attached transparent substrate that makes a color deviation less noticeable even after tiling and an image display device including the same. Since the color deviation is less noticeable after tiling, the quality and the aesthetic appearance of the anti-reflective film-attached transparent substrate and the image display device including the same can be improved.

### BRIEF DESCRIPTION OF DRAWINGS

FIG. 1 is a cross-sectional view schematically showing a configuration example of an anti-reflective film-attached transparent substrate according to an embodiment of the present invention.

FIG. 2 is a schematic diagram illustrating a method of measuring a* and b* of a diffusely reflected light at each angle.

FIG. 3A to FIG. 3D show diagrams showing results of measuring a and b* of a diffusely reflected light at each angle in each example.

### DESCRIPTION OF EMBODIMENTS

Hereinafter, the present invention is described in detail, but the present invention is not limited to the following embodiments, and can be freely modified and implemented without departing from the gist of the present invention. In addition, “to” indicating a numerical range is used to include numerical values written before and after it as a lower limit value and an upper limit value.

Note that, in the present description, “another layer, film, or the like being provided on a main surface of a substrate such as a transparent substrate, on a layer such as a diffusion layer, or on a film such as an anti-reflective film” is not limited to an embodiment in which the another layer, film, or the like is provided in contact with the main surface, layer, or film, but may be an embodiment in which the layer, film, or the like is provided in an upward direction. For example, “including a diffusion layer on a main surface of a transparent substrate” means that the diffusion layer is provided in contact with the main surface of the transparent substrate, or any other layer, film, or the like may be provided between the transparent substrate and the diffusion layer.

An anti-reflective film-attached transparent substrate according to an embodiment of the present invention includes: a transparent substrate having two main surfaces; and a diffusion layer and an anti-reflective film in this order from a transparent substrate side on one main surface of the transparent substrate, in which when reflection on the other main surface of the transparent substrate is eliminated and a light source is incident on the one main surface at an incident angle of 45°, a* and b* of diffusely reflected lights at angles of −15°, 15°, 25°, 45°, 75°, and 110° with respect to a specularly reflected light under a D65 light source satisfy the following formulas (1) to (4).

$$- 6 \leq {a}^{*} \leq 2 \qquad ( 1 )$$

$$- 1 \leq {b}^{*} \leq 12 \qquad ( 2 )$$

$${b}^{*} \leq - 2 {a}^{*} + 4 \qquad ( 3 )$$

$${b}^{*} \geq - 2 {a}^{*} - 5 \qquad ( 4 )$$

### (Anti-Reflective Film-Attached Transparent Substrate)

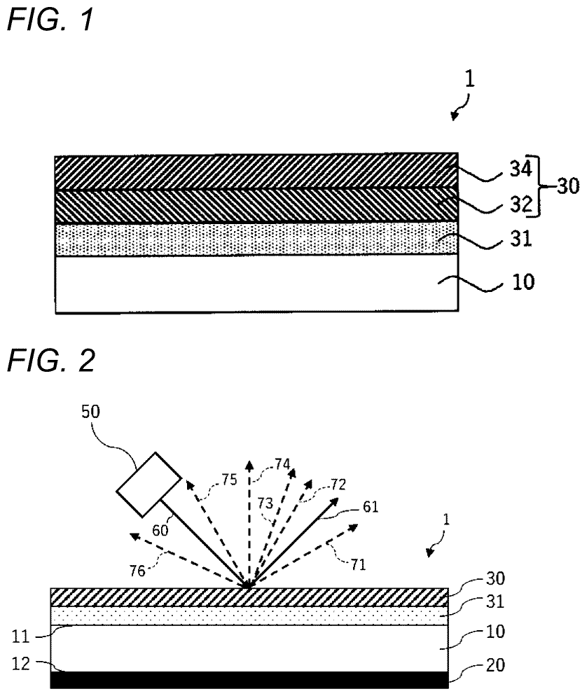

FIG. 1 is a cross-sectional view schematically showing a configuration example of an anti-reflective film-attached transparent substrate according to an embodiment of the present invention. An anti-reflective film-attached transparent substrate 1 shown in FIG. 1 includes a transparent substrate 10, a diffusion layer 31, and an anti-reflective film 30. In FIG. 1, the diffusion layer 31 is formed on one main surface of the transparent substrate 10, and the anti-reflective film 30 is formed on the diffusion layer 31. The anti-reflective film is, for example, a multilayer film having a laminated structure in which at least two dielectric layers having different refractive indices are laminated. In FIG. 1, the anti-reflective film 30 is a multilayer film in which a first dielectric layer 32 and a second dielectric layer 34 are laminated. Note that, FIG. 1 illustrates a configuration in which the diffusion layer 31 is further formed on the transparent substrate 10. However, as to be described later, the diffusion layer may be formed on a surface layer of the transparent substrate itself by a method such as a surface treatment on the transparent substrate.

The anti-reflective film-attached transparent substrate according to the embodiment of the present invention includes a diffusion layer and an anti-reflective film in this order from a transparent substrate side on one main surface of the transparent substrate. Accordingly, it is possible to prevent glare from an external light, and it is possible to obtain an anti-reflective film-attached transparent substrate having reduced whiteness caused by a diffusely reflected light and having an excellent black texture.

In the anti-reflective film-attached transparent substrate according to the embodiment of the present invention, when reflection on the other main surface of the transparent substrate is eliminated and a light source is incident on the one main surface at an incident angle of 45°, a* and b* of diffusely reflected lights at angles of −15°, 15°, 25°, 45°, 75°, and 110° with respect to a specularly reflected light under a D65 light source satisfy the following formulas (1) to (4).

$$- 6 \leq {a}^{*} \leq 2 \qquad ( 1 )$$

$$- 1 \leq {b}^{*} \leq 12 \qquad ( 2 )$$

$${b}^{*} \leq - 2 {a}^{*} + 4 \qquad ( 3 )$$

$${b}^{*} \geq - 2 {a}^{*} - 5 \qquad ( 4 )$$

In the present description, the “diffusely reflected lights at angles of −15°, 15°, 25°, 45°, 75°, and 110°” obtained by the above method may be referred to as “diffusely reflected lights at respective angles”. In addition, in the case of mentioning “a diffusely reflected light at −15°”, it means the diffusely reflected light at −15° among the “diffusely reflected lights at respective angles”, and the same applies when the angle is different. In addition, unless otherwise specified, a*, b*, and L* respectively refer to a*, b*, and L* under a D65 light source.

FIG. 2 is a schematic diagram illustrating a method of measuring a* and b* of a diffusely reflected light at each angle. In the anti-reflective film-attached transparent substrate 1 shown in FIG. 2, the transparent substrate 10 has one main surface 11 and the other main surface 12. The diffusion layer 31 and the anti-reflective film 30 are formed on the one main surface 11. In the measurement method illustrated in FIG. 2, the anti-reflective film-attached transparent substrate 1 has a black tape 20 attached to the other main surface 12 to eliminate the reflection on the other main surface. A light is incident from a light source 50 on the one main surface 11 of the anti-reflective film-attached transparent substrate 1 at an incident angle of 45°. The light source used for incidence is one that emits a light over the entire visible light region. As such a light source, for example, a white light source such as a high color rendering white LED is suitably used. With a specularly reflected light 61 of this incident light 60 being taken as a reference (0°), diffusely reflected lights 71, 72, 73, 74, 75, and 76 are diffusely reflected lights at −15°, 15°, 25°, 45°, 75°, and 110°, respectively. Note that with the angle of the specularly reflected light 61 set to 0°, a direction in which the angle increases toward the incident light 60 is set to a +direction, and a direction in which the angle increases toward a side opposite to the incident light 60 is set to a −direction. For these diffusely reflected lights at respective angles, reflectances in a visible light wavelength are measured, and L*, a* and b* under a D65 light source are calculated. The measurement can be performed using, for example, CM-M6 manufactured by Konica Minolta, Inc. Examples of a method of eliminating the reflection on the other main surface include a method of attaching a black tape to the other main surface as illustrated in FIG. 2. Examples of the black tape used to eliminate the reflection on the other main surface include “KUKKIRI MIERU” manufactured by TOMOEGAWA CORPORATION, and a black tape having a small diffusion reflectance of its own and having little influence on the measurement of the diffusion reflectance of the surface of the transparent substrate having the anti-reflective film can be used.

As a result of intensive studies, the inventors of the present invention have experimentally found that, when a* and b* of diffusely reflected lights at respective angles satisfy the above formulas (1) to (4), it is possible to obtain an anti-reflective film-attached transparent substrate that makes a color deviation less noticeable even after tiling. Thus, the present invention has been completed. That is, “the a* and the b* of the reflected lights at respective angles being different from each other” means that the color tone changes depending on the angle from which the anti-reflective film-attached transparent substrate is viewed. In this way, the change in color tone depending on the viewing angle can generally cause a noticeable color deviation after tiling. However, in the present invention, it has been found that in the case where the a* and the b* of the diffusely reflected lights at respective angles satisfy the above formulas (1) to (4), the change in color tone when the angle is changed is less noticeable. The reasons for this are presumed to be as follows. That is, in the case where the a* and the b* of the diffusely reflected lights at respective angles satisfy the above formulas (1) to (4), depending on the viewing angle, the color tone changes between roughly colorless and yellowish green. It is presumed that within the above color tone range, even when the a* and the b* change depending on the angle, the difference is difficult to perceive and the color deviation is less noticeable. In addition, when the range in which the a* and the b* can change is limited, the magnitude of the change in color tone depending on the angle is relatively small, which is thought to make the color deviation less noticeable. Further, when the above formulas (1) to (4) are satisfied, a color difference between two adjacent anti-reflective film-attached transparent substrates after tiling is limited, and an effect of making boundaries between a plurality of substrates less noticeable can also be expected.

The a* of the diffusely reflected light at each angle is −6≤a*≤2. The a* is −6 or more, preferably −5 or more, and more preferably −4 or more, from the viewpoint of improving a sense of black when the display is turned off. On the other hand, the a* is 2 or less, preferably 1.5 or less, and more preferably 1.0 or less, from the viewpoint of keeping the reflection color between colorless and yellowish green.

The b* of the diffusely reflected light at each angle is −1≤ b*≤12. The b* is −1 or more, preferably −0.9 or more, and more preferably −0.8 or more, from the viewpoint of keeping the reflection color between colorless and yellowish green. On the other hand, the b* is 12 or less, preferably 11 or less, and more preferably 10 or less, from the viewpoint of preventing yellowish green of the reflection color from being noticeable.

The a* and the b* of the diffusely reflected light at each angle satisfy b*≤−2a*+4. Accordingly, the red component can be reduced from the reflection color, which is preferred. The a* and the b* preferably satisfy b*≤−2a*+3.5, and more preferably satisfy b*≤−2a*+3.

The a* and the b* of the diffusely reflected light at each angle satisfy b*≥−2a*−5. Accordingly, the blue component can be reduced from the reflection color, which is preferred. The a* and the b* preferably satisfy b*≥−2a*−4.5, and more preferably satisfy b*≥−2a*−4.

Among the diffusely reflected lights at respective angles, a diffusely reflected light at an angle close to a specularly reflected light of an incident light, for example, diffusely reflected lights at −15°, 15°, and 25°, tends to have a brightness (L*) larger than that of diffusely reflected lights at 45°, 75°, and 110°. The color of a diffusely reflected light having a large brightness is perceived as stronger than the color of a diffusely reflected light having a small brightness. From such viewpoints, the a* and the b* of the diffusely reflected lights at −15°, 15°, and 25° are preferably close to zero, or the L* is preferably a smaller value. Accordingly, among the diffusely reflected lights, the color tone of a light at an angle where it is perceived as stronger is appropriately controlled, so that the color deviation can be made less noticeable.

The L* of the diffusely reflected light at −15° under a D65 light source is preferably 30 to 60, and more preferably 40 to 55. The L* of the diffusely reflected light at −15° under a D65 light source is preferably 30 or more, and more preferably 70 or more. The L* of the diffusely reflected light at −15° under a D65 light source is preferably 60 or less, and more preferably 55 or less. When the L* of the diffusely reflected light at −15° is within this range, the anti-reflective film-attached transparent substrate has appropriate light diffusibility (anti-glare properties) or low reflectivity, and can suitably prevent the glare from the external light.

The L* of the diffusely reflected light at 15° under a D65 light source is preferably 15 to 35, and more preferably 20 to 30. The L* of the diffusely reflected light at 15° under a D65 light source is preferably 15 or more, and more preferably 20 or more. In addition, the L* of the diffusely reflected light at 15° under a D65 light source is preferably 35 or less, and more preferably 30 or less. When the L* of the diffusely reflected light at 15° is within this range, the anti-reflective film-attached transparent substrate has appropriate light diffusibility (anti-glare properties) or low reflectivity, and can suitably prevent the glare from the external light.

The L* of the diffusely reflected light at 25° under a D65 light source is preferably 5 to 20, and more preferably 7 to 15. The L* of the diffusely reflected light at 25° under a D65 light source is preferably 5 or more, and more preferably 7 or more. The L* of the diffusely reflected light at 25° under a D65 light source is preferably 20 or less, and more preferably 15 or less. When the L* of the diffusely reflected light at 25° is within this range, the anti-reflective film-attached transparent substrate has appropriate light diffusibility (anti-glare properties) or low reflectivity, and can suitably prevent the glare from the external light.

In addition, it is preferable that the L* of the diffusely reflected light at −15° be 30 to 60, the L* of the diffusely reflected light at 15° be 15 to 35, and the L* of the diffusely reflected light at 25° be 5 to 20 under a D65 light source. Accordingly, the anti-reflective film-attached transparent substrate has more suitable light diffusibility (anti-glare properties) or low reflectivity, and can suitably prevent the glare from the external light. The L* of the diffusely reflected light at each angle is measured and calculated in the same manner as the a* and the b*, for example, using a CM-M6 manufactured by Konica Minolta, Inc.

In the anti-reflective film-attached transparent substrate according to the embodiment of the present invention, a haze value is preferably 30% or more, more preferably 40% or more, and still more preferably 50% or more, from the viewpoint of suitably preventing the glare. The haze value is preferably, for example, 90% or less, from the viewpoint of improving the clarity of an image when the anti-reflective film-attached transparent substrate is used in an image display device. The haze value may be 30% to 90%.

An anti-reflective film-attached transparent substrate having a relatively large haze value as described above is suitably used for a large μ-LED display application. The first reason is that when the display is large, the glare from illumination or an external light is more likely to occur, and therefore it is necessary to more suitably prevent the glare. The second reason is that, since a pixel pitch of a large μ-LED display is relatively large, even when the haze value is relatively large, it tends to be a high definition display. However, in an anti-reflective film-attached transparent substrate having a relatively large haze value, the amount of diffusely reflected components is larger, so that the change in color tone depending on the angle of the diffusely reflected light tends to be particularly remarkable. In contrast, according to the present invention, even when the haze value is relatively large, the color deviation after tiling can be suitably reduced.

Note that, in applications such as a LCD display, for example, an anti-reflective film-attached transparent substrate having a haze value of about 0% to 30% is suitably used. As long as the effects of the present invention can be obtained, the haze value is not limited to being, for example, 30% or less, or less than 30%, depending on the application or the like.

The haze value can be adjusted, for example, according to the surface shape of the diffusion layer. The haze value is measured according to JIS K 7136:2000 using a haze meter (HZ-V3 manufactured by Suga Test Instruments Co., Ltd.) or the like.

### (Luminous Transmittance: Y)

The anti-reflective film-attached transparent substrate according to the present embodiment preferably has a luminous transmittance (Y) of 20% to 90%. In the case where the luminous transmittance (Y) is within the above range, the anti-reflective film-attached transparent substrate has an appropriate light absorption ability. Therefore, in the case where the anti-reflective film-attached transparent substrate is used as a cover glass of an image display device, light reflection can be prevented. Accordingly, a bright contrast of the image display device is improved. The luminous transmittance (Y) is more preferably 50% to 90%, and still more preferably 60% to 90%. That is, the luminous transmittance (Y) is preferably 20% or more, more preferably 50% or more, and still more preferably 60% or more. The luminous transmittance (Y) is preferably 90% or less.

Note that, the luminous transmittance (Y) can be measured according to the method specified in JIS Z 8701 (1999), as to be described later in Examples.

In the anti-reflective film-attached transparent substrate according to the present embodiment, in order to obtain a luminous transmittance (Y) of 20% to 90%, for example, as a first dielectric layer of the anti-reflective film, it is preferable to mainly use a mixed oxide of an oxide containing at least one selected from the group A consisting of Mo and W and an oxide containing at least one selected from the group B consisting of Si, Nb, Ti, Zr, Ta, Al, Sn, and In, to adjust an amount of oxidation of the film.

The luminous transmittance (Y) of the anti-reflective film-attached transparent substrate according to the present embodiment can be adjusted, for example, by controlling an irradiation time and an irradiation output of an oxidation source, a distance from the substrate, and an amount of oxidation gas during film-formation of the first dielectric layer in the above anti-reflective film, which is a high refractive index layer.

### (Sheet Resistance)

In the anti-reflective film-attached transparent substrate according to the present embodiment, the anti-reflective film preferably has a sheet resistance of 10⁴Ω/□ or more. When the sheet resistance of the anti-reflective film is within the above range, the anti-reflective film has an insulating property. Therefore, in the case where the anti-reflective film-attached transparent substrate is used as a cover glass of an image display device, even when a touch panel is provided, a change in capacitance due to finger contact, which is necessary for a capacitive touch sensor, is maintained, and the touch panel functions. The sheet resistance is more preferably 10⁶Ω/□ or more, and still more preferably 10⁸Ω/□ or more.

Note that, the sheet resistance can be measured according to the method specified in JIS K 6911 (2006), as to be described later in Examples.

In order to set the sheet resistance of the anti-reflective film to 10⁴Ω/□ or more in the anti-reflective film-attached transparent substrate according to the present embodiment, for example, the metal content in the anti-reflective film is adjusted.

### (b* Value of Transmission Color Under D65 Light Source)

In the anti-reflective film-attached transparent substrate according to the present embodiment, a b* value of a transmission color under a D65 light source is preferably 5 or less. When the b* value is within the above range, the transmitted light is not yellowish, so that it is suitable for use as a cover glass of an image display device. The b* value is more preferably 3 or less, and still more preferably 2 or less. In addition, the b* value has a lower limit value of preferably −6 or more, and more preferably −4 or more. The b* value is preferably within the above range since the transmitted light is colorless and the transmitted light is not hindered. The b* value of a transmission color under a D65 light source may be −6 to 5.

Note that, the b* value of a transmission color under a D65 light source can be measured according to the method specified in JIS Z 8729 (2004).

### (Transparent Substrate)

In the present embodiment, the transparent substrate having two main surfaces (hereinafter, also simply referred to as the transparent substrate) preferably has a refractive index of 1.4 or more and 1.7 or less. When the refractive index of the transparent substrate is within the above range, reflection at an adhesion surface can be sufficiently prevented in the case of optically adhering a display, a touch panel, or the like. The refractive index is more preferably 1.45 or more, still more preferably 1.47 or more, and is more preferably 1.65 or less, still more preferably 1.6 or less.

The transparent substrate preferably includes at least one of a glass and a resin. More preferably, the transparent substrate includes both a glass and a resin. When the transparent substrate includes a glass, strength, flatness, and durability of the anti-reflective film-attached transparent substrate can be made excellent. In addition, a diffusion layer can be easily formed by attaching a laminate formed of a resin substrate and an anti-glare layer, to be described later, on a glass substrate. In the anti-reflective film-attached transparent substrate on which the diffusion layer is formed by this method, the transparent substrate includes both a glass and a resin.

In the case where the transparent substrate includes a glass, the kind of the glass is not particularly limited, and glasses having various compositions can be used. Among them, the glass preferably contains sodium and preferably has a composition that allows molding and strengthening by a chemical strengthening treatment. Specific examples of the glass include an aluminosilicate glass, a soda lime glass, a borosilicate glass, a lead glass, an alkali barium glass, and an aluminoborosilicate glass.

Note that, in the present description, in the case where the transparent substrate includes a glass, the transparent substrate is also called a glass substrate.

The thickness of the glass substrate is not particularly limited, and in the case of subjecting the glass to a chemical strengthening treatment, for example, the thickness is preferably 5 mm or less, more preferably 3 mm or less, and still more preferably 1.5 mm or less, in order to effectively perform the chemical strengthening. In addition, the thickness is, for example, 0.2 mm or more. The thickness of the glass substrate may be 0.2 mm to 5 mm.

The glass substrate is preferably a chemically strengthened glass obtained by chemical strengthening. Accordingly, the strength of the anti-reflective film-attached transparent substrate is increased. Note that, in the case where the glass substrate is subjected to an anti-glare treatment to be described later, the chemical strengthening is preferably performed after the anti-glare treatment and before forming the anti-reflective film (multilayer film).

In the case where the transparent substrate includes a resin, the kind of the resin is not particularly limited, and resins having various compositions can be used. Among them, the resin is preferably a thermoplastic resin or a thermosetting resin. Examples thereof include a polyvinyl chloride resin, a polyethylene resin, a polypropylene resin, a polystyrene resin, a polyvinyl acetate resin, a polyester resin, a polyurethane resin, a cellulose-based resin, an acrylic resin, an AS (acrylonitrile-styrene) resin, an ABS (acrylonitrile-butadiene-styrene) resin, a fluorine-based resin, a thermoplastic elastomer, a polyamide resin, a polyimide resin, a polyacetal resin, a polycarbonate resin, a modified polyphenylene ether resin, a polyethylene terephthalate resin, a polybutylene terephthalate resin, a polylactic acid-based resin, a cyclic polyolefin resin, and a polyphenylene sulfide resin. Among them, a cellulose-based resin is preferred, and examples thereof include a triacetyl cellulose resin, a polycarbonate resin, and a polyethylene terephthalate resin. These resins may be used alone or in combination of two or more kinds thereof.

The resin particularly preferably includes at least one resin selected from polyethylene terephthalate, a polycarbonate, acrylic, silicone, and triacetyl cellulose, from the viewpoint of excellent visible light transparency and easy availability.

Note that, in the present description, in the case where the transparent substrate includes a resin, the transparent substrate is also called a resin substrate.

The resin substrate is preferably in the form of a film. In the case where the resin substrate is in the form of a film, that is, when it is a resin film, the thickness is not particularly limited, and is preferably 20 μm to 300 μm, and more preferably 30 μm to 130 μm.

Examples of the case where the transparent substrate includes both a glass and a resin include a case of a composite substrate in which a glass substrate and a resin substrate are laminated. More specifically, the transparent substrate may be, for example, in a form in which the above resin substrate is provided on the above glass substrate.

### (Diffusion Layer)

The diffusion layer in the present embodiment is provided on one main surface of the transparent substrate. The diffusion layer means a layer having a function of diffusing the specularly reflected light and reducing the glare and the reflection, and examples thereof include an anti-glare layer in which the function of diffusing the specularly reflected light (anti-glare properties) is imparted in the hard coat layer.

The anti-glare layer has irregularities on one surface thereof, and thereby causes external scattering or internal scattering, increasing the haze value and imparting anti-glare properties. The anti-glare layer is formed of, for example, an anti-glare layer composition obtained by dispersing, in a solution in which a polymer resin as a binder is dissolved, a particulate substance having at least anti-glare properties in itself. The anti-glare layer can be formed, for example, by coating one main surface of the transparent substrate with the anti-glare layer composition.

Examples of the particulate substance having anti-glare properties include inorganic fine particles such as silica, clay, talc, calcium carbonate, calcium sulfate, barium sulfate, aluminum silicate, titanium oxide, synthetic zeolite, alumina, and smectite, and organic fine particles including a styrene resin, a urethane resin, a benzoguanamine resin, a silicone resin, an acrylic resin, a melamine resin, or the like.

In addition, as the polymer resin as a binder for the hard coat layer or the anti-glare layer, for example, polymer resins such as a polyester-based resin, an acrylic resin, an acrylic urethane-based resin, a polyester acrylate-based resin, a polyurethane-based acrylate resin, an epoxy acrylate-based resin, and a urethane-based resin can be used.

In the present embodiment, the diffusion layer may be formed directly on the transparent substrate, or a laminate formed of a resin substrate and an anti-glare layer may be prepared in advance and then attached to a glass substrate or the like to obtain a configuration in which a diffusion layer is provided on a composite substrate of a glass substrate and a resin substrate. Such a laminate is preferably one in which a diffusion layer is formed on a film-like resin substrate. According to this method, the diffusion layer can be formed more easily.

Specific examples of the laminate formed of a resin substrate and an anti-glare layer include an anti-glare PET film and an anti-glare TAC film. Examples of the anti-glare PET film include trade name: BHC-III and EHC-30a manufactured by Higashiyama Film Co., Ltd., and those manufactured by REIKO Co., Ltd. In addition, examples of the anti-glare TAC film include an anti-glare TAC film (trade name: VZ50 manufactured by TOPPAN TOMOEGAWA Optical Films Co., Ltd.), and an anti-glare TAC film (trade name: VH66H manufactured by TOPPAN TOMOEGAWA Optical Films Co., Ltd.).

Alternatively, the diffusion layer may be formed on the surface layer of the transparent substrate itself by subjecting the transparent substrate to a surface treatment.

For example, in the case of using a glass substrate, a method of subjecting a main surface of a glass to a surface treatment to form desired irregularities can be used.

Specifically, a method of chemically treating the main surface of the glass substrate, for example, a method of applying a frost treatment, can be used. The frost treatment can be performed, for example, by immersing a glass substrate to be treated in a mixed solution containing hydrogen fluoride and ammonium fluoride, and subjecting the immersed surface to a chemical surface treatment.

In addition to chemical treatment methods such as a frost treatment, for example, a method by a physical treatment can also be used including a so-called sandblast treatment in which a crystalline silicon dioxide powder, a silicon carbide powder, or the like is blown onto the surface of the glass substrate with pressurized air, and polishing with a brush to which a crystalline silicon dioxide powder, a silicon carbide powder or the like adheres is moistened with water.

The anti-reflective film-attached transparent substrate including such a diffusion layer has an irregular shape on the surface due to the irregular shape of the diffusion layer. The anti-reflective film-attached transparent substrate has an arithmetic mean surface roughness (Sa) of preferably 0.05 μm to 0.6 μm, and more preferably 0.05 μm to 0.55 μm. The Sa is preferably within this range since it is easier to prevent glare of a reflected image. The Sa is specified in ISO25178, and can be measured, for example, using a laser microscope VK-X3000 manufactured by Keyence Corporation.

In the anti-reflective film-attached transparent substrate, a developed area ratio Sdr (hereinafter, simply referred to as “Sdr”) calculated based on the surface area obtained by measurement using a laser microscope such as VK-X3000 manufactured by Keyence Corporation is preferably 0.001 to 0.4, and more preferably 0.0025 to 0.2. The Sdr is preferably within this range since it is easier to prevent the glare of the reflected image.

The Sdr is specified in ISO25178 and is represented by the following equation.

$$Developed area ratio Sdr = \{ ( A - B ) / B \}$$

A: surface area (developed area) reflecting actual irregularities in measurement region
B: area of flat surface without any irregularities in measurement region

The anti-reflective film-attached transparent substrate has a root mean square slope (Sdq) of preferably 0.03 to 0.50, and more preferably 0.07 to 0.49. The Sdq is preferably within this range since it is easier to prevent the glare of the reflected image. The Sdq is specified in ISO25178, and can be measured, for example, using a laser microscope VK-X3000 manufactured by Keyence Corporation.

The anti-reflective film-attached transparent substrate has an average principal curvature of surface peaks (Spc) of preferably 150 to 6000 (1/mm). The Spc is preferably within this range since it is easier to prevent the glare of the reflected image. The Spc is specified in ISO25178, and can be measured, for example, using a laser microscope VK-X3000 manufactured by Keyence Corporation.

Note that, the above Sa, Sdr, Sdq, and Spc refer to values measured on the main surface of the anti-reflective film-attached transparent substrate on the side where the diffusion layer and the anti-reflective film are provided.

### (Barrier Layer)

In the case where the transparent substrate includes a resin substrate, such as in the case of forming the diffusion layer by the method of attaching the laminate formed of a resin substrate and an anti-glare layer to a glass substrate, a barrier layer is preferably provided between the diffusion layer and the anti-reflective film. The barrier layer is preferably provided between the resin transparent substrate and the anti-reflective film, since there are advantages that influences of moisture and oxygen that try to penetrate the anti-reflective film from the resin substrate can be prevented and optical properties are less likely to change. Examples of the barrier layer include a metal nitride film and a metal oxide film, and specific examples thereof include a SiNₓ film or a SiOₓ film. A SiNₓ film is more preferred from the viewpoint of more effectively preventing a change in optical properties. From the viewpoint of preventing moisture from penetrating the anti-reflective film, the thickness of the barrier layer is preferably 2 nm or more, more preferably 4 nm or more, and particularly preferably 8 nm or more. On the other hand, from the viewpoint of preventing an increase in reflectance of the anti-reflective film-attached transparent substrate, the thickness is preferably 50 nm or less. The barrier layer can be formed by using, for example, a known film-forming method such as a sputtering method, a vacuum deposition method, or a coating method.

### (Anti-Reflective Film)

The anti-reflective film in the present embodiment has a function of preventing the light reflection, and has, for example, a laminated structure in which at least two dielectric layers having different refractive indices are laminated.

The anti-reflective film (multilayer film) 30 shown in FIG. 1 has a laminated structure including two layers in which the first dielectric layer 32 and the second dielectric layer 34 having different refractive indices are laminated. When the first dielectric layer 32 and the second dielectric layer 34 having different refractive indices are laminated, the light reflection can be prevented. For example, in FIG. 1, the first dielectric layer 32 is a high refractive index layer and the second dielectric layer 34 is a low refractive index layer.

It is preferable that the anti-reflective film have a laminated structure in which at least two dielectric layers having different refractive indices are laminated, at least one of the dielectric layers be mainly formed of a Si oxide, at least another layer among layers in the laminated structure be mainly formed of a mixed oxide of an oxide containing at least one selected from the group A consisting of Mo and W and an oxide containing at least one selected from the group B consisting of Si, Nb, Ti, Zr, Ta, Al, Sn, and In, and a content of elements of the group B contained in the mixed oxide be 65 mass % or less with respect to a total of elements of the group A contained in the mixed oxide and the elements of the group B contained in the mixed oxide. The layer mainly formed of a Si oxide may contain an oxide containing at least one selected from Nb, Ti, Zr, Ta, Al, Sn, W, Mo, and In in a range that the reflectance is not influenced. When the anti-reflective film has the above configuration, it is possible to obtain an anti-reflective film having an insulating property and a uniform light absorption ability in the visible light region. When the anti-reflective film has an light absorption ability, for example, in a configuration in which the anti-reflective film is formed on a diffusion layer, the light reflected on the surface of the diffusion layer (that is, on the transparent substrate side of the anti-reflective film) can be absorbed to a certain extent. Accordingly, since the whiteness caused by the diffuse reflection at the diffusion layer can be more effectively prevented, the black texture can be further improved when the anti-reflective film-attached transparent substrate is used in an image display device with the screen turned off. In addition, when the anti-reflective film has an insulating property, the anti-reflective film-attached transparent substrate can also be suitably used for applications such as a touch panel. When components contained in the dielectric layer are set within an appropriate range, it is possible to obtain an anti-reflective film having little change in optical properties and appearance, for example, even in harsh environments such as a high temperature environment of 80° C. or 95° C., a high temperature and high humidity environment such as a temperatures and a humidity of 65° C./95% or 85° C./85%, an environment exposed to strong UV light, and an environment exposed to rain.

In the anti-reflective film (multilayer film) 30 shown in FIG. 1, the first dielectric layer 32 (high refractive index layer) is preferably mainly formed of a mixed oxide of an oxide containing at least one selected from the group A consisting of Mo and W and an oxide containing at least one selected from the group B consisting of Si, Nb, Ti, Zr, Ta, Al, Sn, and In. In the mixed oxide, a content of elements of the group B contained in the mixed oxide (hereinafter, referred to as a group B content) is preferably 65 mass % or less with respect to a total of elements of the group A contained in the mixed oxide and the elements of the group B contained in the mixed oxide. Here, “mainly” means a component that has the largest content (in terms of mass) in the first dielectric layer 32, and means that the first dielectric layer 32 contains, for example, 70 mass % or more of the component.

When the group B content in the first dielectric layer (A-B-O) 32, which is formed of the mixed oxide of an oxide containing at least one selected from the group A consisting of Mo and W and an oxide containing at least one selected from the group B consisting of Si, Nb, Ti, Zr, Ta, Al, Sn, and In, is 65 mass % or less, it is possible to prevent the transmitted light from being yellowish.

The oxide containing at least one selected from the group A is preferably Mo, or Mo and W, and the oxide containing at least one selected from the group B is preferably Nb. That is, the first dielectric layer is preferably a mixed oxide containing Mo and Nb or a mixed oxide containing Mo, W, and Nb, and more preferably a mixed oxide containing Mo, W, and Nb.

As to be described later, the second dielectric layer may be, for example, an oxygen-deficient silicon oxide layer. Here, the oxygen-deficient silicon oxide layer in the related art is yellowish when exposed to a visible light. However, the first dielectric layer is preferably made of a mixed oxide containing Mo and Nb or a mixed oxide containing Mo, W, and Nb, since this can prevent the silicon oxide layer from being yellowish. In addition, for the purpose of improving the reliability, the silicon oxide layer may contain an oxide containing at least one selected from the group consisting of Nb, Ti, Zr, Ta, Al, Sn, W, Mo, and In, and each oxide may have oxygen deficiency. Further, in the case of forming the second dielectric layer on the diffusion layer having a relatively high haze as described above, that is, relatively large surface irregularities, high oxidation stability is required during the film formation. The first dielectric layer is more preferably a mixed oxide containing Mo, W, and Nb since this tends to provide excellent oxidation stability during the film formation.

The first dielectric layer 32 has a refractive index at a wavelength of 550 nm of preferably 1.8 to 2.3 from the viewpoint of a transmittance with the transparent substrate.

The first dielectric layer 32 has an extinction coefficient of preferably 0.005 to 3, and more preferably 0.04 to 0.38. When the extinction coefficient is 0.005 or more, a desired absorption rate can be achieved with an appropriate number of layers. In addition, when the extinction coefficient is 3 or less, it is relatively easy to achieve both the reflection color tone and the transmittance.

The second dielectric layer 34 (low refractive index layer) is preferably mainly formed of a Si oxide (SiOₓ). Here, “mainly” means a component that has the largest content (in terms of mass) in the second dielectric layer 34, and means that the second dielectric layer 34 contains, for example, 70 mass % or more of the component. The second dielectric layer 34 (low refractive index layer) is preferably mainly formed of a Si oxide (SiOₓ) since the refractive index is low and a reflectance reduction effect is high. Note that, SiOₓ may be fully oxidized silicon oxide (SiO₂), but from the viewpoint of improving optical reliability and scratch resistance, SiOₓ is preferably an oxygen-deficient silicon oxide. In addition, for the purpose of improving the reliability, the silicon oxide layer may contain an oxide containing at least one selected from the group consisting of Nb, Ti, Zr, Ta, Al, Sn, W, Mo, and In, and each oxide may have oxygen deficiency.

The anti-reflective film (multilayer film) 30 shown in FIG. 1 has a two-layer laminated structure in which the first dielectric layer 32 and the second dielectric layer 34 are laminated. The anti-reflective film (multilayer film) in the present embodiment is not limited to this, and may have a laminated structure in which three or more dielectric layers having different refractive indices are laminated. In this case, it is not necessary for all dielectric layers to have different refractive indices. That is, the laminated structure may be a laminated structure in which two or more dielectric layers are laminated such that adjacent layers have different refractive indices, and the number of laminated layers may be three or more. For example, in the case of a three-layer laminated structure, it can be a three-layer laminated structure including a low refractive index layer, a high refractive index layer, and a low refractive index layer, or a three-layer laminated structure including a high refractive index layer, a low refractive index layer, and a high refractive index layer. In the former case, the two low refractive index layers may have the same refractive index, and in the latter case, the two high refractive index layers may have the same refractive index. In the case of a four-layer laminated structure, it can be a four-layer laminated structure including a low refractive index layer, a high refractive index layer, a low refractive index layer, and a high refractive index layer, or a four-layer laminated structure including a high refractive index layer, a low refractive index layer, a high refractive index layer, and a low refractive index layer. In this case, at least one of the two low refractive index layers and the two high refractive index layers may have the same refractive index.

In the case of a laminated structure in which three or more layers having different refractive indices are laminated, a dielectric layer other than the first dielectric layer (A-B-O) 32 and the second dielectric layer (SiOₓ) 34 may be included. In this case, each layer is selected to form a three-layer laminated structure including a low refractive index layer, a high refractive index layer, and a low refractive index layer, or a three-layer laminated structure including a high refractive index layer, a low refractive index layer, and a high refractive index layer, or a four-layer laminated structure including a low refractive index layer, a high refractive index layer, a low refractive index layer, and a high refractive index layer, or a four-layer laminated structure including a high refractive index layer, a low refractive index layer, a high refractive index layer, and a low refractive index layer, each laminated structure including the first dielectric layer (A-B-O) 32 and the second dielectric layer (SiOₓ) 34.

The outermost layer is preferably the second dielectric layer (SiOₓ) 34. When the outermost layer is the second dielectric layer (SiOₓ) in order to obtain low reflectivity, production is relatively easy. In addition, although the reflectance may increase slightly, for the purpose of improving the reliability, the second dielectric layer may contain an oxide containing at least one selected from the group consisting of Nb, Ti, Zr, Ta, Al, Sn, W, Mo, and In. In order to prevent the increase in reflectance, the content of metals other than Si, excluding oxygen, is preferably 30 at % or less, more preferably 20 at % or less, and still more preferably 15 at % or less. In addition, in the case of forming an antifouling film to be described later on the anti-reflective film 30, it is preferable to form the antifouling film on the second dielectric layer (SiOₓ) from the viewpoint of bonding properties related to the durability of the antifouling film.

The first dielectric layer (A-B-O) 32 is preferably amorphous. Being amorphous, it can be produced at a relatively low temperature, and is suitable for use in the case where the transparent substrate includes a resin, since the resin is not damaged by heat.

Note that, as a light transmitting film having a light absorption ability and an insulating property, a halftone mask for use in the semiconductor production field is known. As the halftone mask, an oxygen-deficient film such as a Mo-SiOₓ film containing a small amount of Mo is used. In addition, as the light transmitting film having a light absorption ability and an insulating property, a narrow bandgap film for use in the semiconductor production field is known.

However, these light transmitting films have a high light absorption ability on the short wavelength side of the visible light, so that the transmitted light is yellowish. Therefore, these films are not suitable for a cover glass of an image display device.

In a preferred embodiment of the present invention, when the first dielectric layer 32 has a high content of Mo or W and the second dielectric layer 34 is formed of SiOₓ or the like, it is possible to obtain an anti-reflective film-attached transparent substrate having a light absorption ability, an insulating property, and excellent adhesion and strength.

The anti-reflective film 30 in the present embodiment can be formed on the main surface of the transparent substrate using a known film-forming method such as a sputtering method, a vacuum deposition method, or a coating method. That is, the dielectric layers constituting the anti-reflective film 30 are formed on the main surface of the diffusion layer 31, according to the lamination order, using a known film-forming method such as a sputtering method, a vacuum deposition method, or a coating method.

Examples of the sputtering method include methods such as magnetron sputtering, pulse sputtering, AC sputtering, and digital sputtering.

For example, the magnetron sputtering method is a method in which a magnet is placed on a back surface of a base dielectric material to generate a magnetic field, and gas ion atoms collide with the surface of the dielectric material and are ejected, to form a sputtering film having a thickness of several nm, and a continuous film of a dielectric that is an oxide or a nitride of the dielectric material can be formed.

In addition, for example, the digital sputtering method is a method of forming a metal oxide thin film by repeating steps of first forming a metal ultra-thin film by sputtering, and then oxidizing the film by irradiation with oxygen plasma, oxygen ions, or oxygen radicals in the same chamber, unlike a general magnetron sputtering method. In this case, since film-forming molecules are metals when deposited on a substrate, it is presumed to be more ductile than a case of depositing a metal oxide. Therefore, it is thought that even when the energy is the same, rearrangement of the film-forming molecules is likely to occur, and as a result, a dense and smooth film can be formed.

Note that, an example of a preferred configuration of the anti-reflective film has been given above, but the configuration of the anti-reflective film is not limited to this. For example, when it is desired to keep high luminance of a display, an anti-reflective film that does not have a light absorption ability or that has a relatively high transmittance and has a luminous transmittance of 90% or more as an anti-reflective film-attached transparent substrate may be suitably used. In such an anti-reflective film-attached transparent substrate including an anti-reflective film having a high transmittance, the effect of reducing the color deviation after tiling can also be obtained as long as the a* and the b* of the diffusely reflected lights at respective angles are within the above ranges. Examples of a configuration including the anti-reflective film having a high transmittance include a configuration in which a low refractive index layer is similar to the above second dielectric layer 34, while a high refractive index layer is a layer that does not have a light absorption ability or that has a high transmittance. Examples of the high refractive index layer in this case include a layer mainly formed of a Ti oxide (TiOₓ), a layer formed of a Nb oxide (NbOₓ), and a layer formed of a Ta oxide (TaOₓ), and a layer mainly formed of a Ti oxide (TiOₓ) is preferred from the viewpoint of reducing the reflectance. In this case, each layer constituting the anti-reflective film can also be formed using a known film-forming method such as a sputtering method, a vacuum deposition method, or a coating method.

The luminous transmittance (Y) of the anti-reflective film-attached transparent substrate in the case of including the anti-reflective film having a high transmittance may be, for example, 90% to 96%, and is preferably 93% to 96%.

### (Antifouling Film)

The anti-reflective film-attached transparent substrate according to the present embodiment may further include an antifouling film (also referred to as an “anti finger print (AFP) film”) on the anti-reflective film, from the viewpoint of protecting the outermost surface of the anti-reflective film. The antifouling film can be formed of, for example, a fluorine-containing organosilicon compound. The fluorine-containing organosilicon compound is not particularly limited as long as it can impart an antifouling property, water repellency, and oil repellency, and examples thereof include a fluorine-containing organosilicon compound having one or more groups selected from the group consisting of a polyfluoropolyether group, a polyfluoroalkylene group, and a polyfluoroalkyl group. Note that, the polyfluoropolyether group is a divalent group having a structure in which polyfluoroalkylene groups and etheric oxygen atoms are alternately bonded.

As a commercially available fluorine-containing organosilicon compound having one or more groups selected from the group consisting of a polyfluoropolyether group, a polyfluoroalkylene group, and a polyfluoroalkyl group, KP-801 (trade name, manufactured by Shin-Etsu Chemical Co., Ltd.), KY178 (trade name, manufactured by Shin-Etsu Chemical Co., Ltd.), KY-130 (trade name, manufactured by Shin-Etsu Chemical Co., Ltd.), KY-185 (trade name, manufactured by Shin-Etsu Chemical Co., Ltd.), and Optool (registered trademark) DSX and Optool AES (trade name, all manufactured by Daikin Industries, Ltd.) can be preferably used.

In the case where the anti-reflective film-attached transparent substrate according to the present embodiment includes an antifouling film, the antifouling film is provided on the anti-reflective film. In the case where the anti-reflective film is provided on both main surfaces of the transparent substrate, the antifouling film can be formed on both the anti-reflective films, or the antifouling film may be laminated on only one of the main surfaces. This is because the antifouling film only needs to be provided at places where there is a possibility of contact with human hands, and the configuration can be selected according to the application.

### (Method for Producing Anti-Reflective Film-Attached Transparent Substrate)

A method for producing an anti-reflective film-attached transparent substrate according to the present embodiment is not particularly limited, and for example, the anti-reflective film-attached transparent substrate can be produced by a method including forming a diffusion layer and an anti-reflective film in this order on a transparent substrate. If necessary, the method may further include forming a layer such as a barrier layer or an antifouling film.

The method for forming each layer is as described above. In order for the a* and the b* of the diffusely reflected lights at respective angles to satisfy the above formulas (1) to (4), it is preferable to appropriately adjust the film configuration of the anti-reflective film and values such as the luminous transmittance (Y) of the anti-reflective film-attached transparent substrate. In the case of an anti-reflective film-attached transparent substrate having a high transmittance, it is difficult to optimize the transmittance, so that it is preferable to more strictly adjust the thickness of each layer of the anti-reflective film. As a specific adjustment method, it is preferable to set a specular reflectance for a yellowish green light having a wavelength of about 500 nm to 600 nm to be larger than that for a blue light having a wavelength of 450 nm to 500 nm and that for a red light having a wavelength of 600 nm to 650 nm at a plurality of light incident angles. Accordingly, specular reflection colors can be kept from black (colorless) to yellowish green at a plurality of light incident angles, and as a result, the diffusion reflection colors at a plurality of incident angles also tend to be kept from black (colorless) to yellowish green. An angle dependency of the specular reflection color can be easily predicted by using thin film simulation software. When the (1) to (4) are satisfied, in particular, since the reflection color maintains yellowish green while the brightness gradually changes at −15° to 45°, at which the brightness is large, the configuration does not give a particularly strange feeling when visually observed.

For example, in the case where the high refractive index layer is a mixed oxide layer containing Mo, W, and Nb, and the low refractive index layer is a SiOₓ layer, when the following is satisfied, it is easy to obtain an anti-reflective film-attached transparent substrate in which the a* and the b* of the diffusely reflected lights at respective angles satisfy the above formulas (1) to (4).

For example, the anti-reflective film has a total thickness of preferably 200 nm to 250 nm, and more preferably 210 nm to 245 nm. Accordingly, the angle dependency of the diffusion reflection color, that is, an increase in change in color tone of the diffusely reflected light depending on the angle can be prevented, and the formulas (1) to (4) tend to be easily satisfied.

The number of layers in the anti-reflective film is preferably 4 to 8 layers, and more preferably 4 to 6 layers. Accordingly, an increase in angle dependency of the diffusion reflection color can be prevented while ensuring mass productivity, and the formulas (1) to (4) tend to be easily satisfied.

Regarding the thickness of each layer, the thickness of the first high refractive index layer is the most important, and is preferably 1 nm to 25 nm, and more preferably 2 nm to 15 nm. Accordingly, the angle dependency of the diffusion reflection color, that is, an increase in change in color tone of the diffusely reflected light depending on the angle can be prevented, and the formulas (1) to (4) tend to be easily satisfied.

### (Application)

The anti-reflective film-attached transparent substrate according to the present embodiment is suitably used as, for example, a cover glass of an image display device, in particular, as a cover glass of a display obtained by tiling a plurality of displays (for example, LED panels), such as a large μ-LED display. Alternatively, the anti-reflective film-attached transparent substrate according to the present embodiment is also suitably used in the case where the haze required for the anti-reflective film-attached transparent substrate is relatively high and the change in color tone depending on the angle tends to be more remarkable. In addition, the anti-reflective film-attached transparent substrate according to the present embodiment is also suitably used as a cover glass of various other image display devices such as a liquid crystal display, an organic EL display, and an electronic paper display.

### (Image Display Device)

An image display device according to one embodiment of the present invention includes the above anti-reflective film-attached transparent substrate. Examples of the image display device include an embodiment including the above anti-reflective film-attached transparent substrate on a small display (for example, an LED panel) that is used in a tiled manner, and a large display obtained by tiling these displays, preferably a large μ-LED display. Examples also include an embodiment including the above anti-reflective film-attached transparent substrate on various displays such as a liquid crystal display, an organic EL display, and an electronic paper display.

### EXAMPLES

Hereinafter, the present invention is described in detail with reference to Examples, but the present invention is not limited thereto. Example 1 and Example 2 are Comparative Examples, and Example 3 and Example 4 are Inventive Examples.

### (Evaluation)

The following evaluation was performed on the anti-reflective film-attached transparent substrate in each example.

### (a*, b*, and L* of Diffusely Reflected Light at Each Angle)

A black tape (“KUKKIRI MIERU” manufactured by TOMOEGAWA CORPORATION) was attached to the main surface (the other main surface) of the anti-reflective film-attached transparent substrate not having the diffusion layer or the anti-reflective film. Accordingly, while eliminating the reflection on the other main surface, a light source was incident on the main surface (the one main surface) having the diffusion layer and the anti-reflective film at an incident angle of 45°. The reflectance at a visible light wavelength was measured for diffusely reflected lights at angles of −15°, 15°, 25°, 45°, 75°, and 110° with respect to the specularly reflected light, and the a*, the b* and the L* under a D65 light source were calculated (diffusion reflection color). Note that, the measurement was performed using CM-M6 manufactured by Konica Minolta, Inc.

### (Haze)

The haze value (transmitted haze) of the prepared anti-reflective film-attached transparent substrate was measured using a haze meter (HZ-V3 manufactured by Suga Test Instruments Co., Ltd.) according to JIS K 7136:2000.

### (Luminous Transmittance: Y)

In the prepared anti-reflective film-attached transparent substrate, the luminous transmittance (Y) on the outermost surface of the anti-reflective film was measured according to the method specified in JIS Z 8701 (1999). Note that, in the present description, the luminous transmittance (Y) on the outermost surface of the anti-reflective film was taken as the luminous transmittance (Y) of the anti-reflective film-attached transparent substrate. Specifically, of two main surfaces of the transparent substrate, a black tape was attached to the other main surface, which was not the main surface facing the anti-reflective film, to eliminate back surface reflection. In this state, the spectral transmittance was measured using a spectrophotometer (trade name: SolidSpec-3700 manufactured by Shimadzu Corporation), and the luminous transmittance (a stimulus value Y specified in JIS Z 8701 (1999)) was obtained by calculation.

### (Transmission Color (b* Value) of Anti-Reflective Film-Attached Transparent Substrate Under D65 Light Source)

The color index (b* value) specified in JIS Z 8729 (2004) was determined based on a transmission spectrum obtained by measuring the above spectral transmittance. As the light source, a D65 light source was used.

### (Color Deviation Evaluation)

For each example, 16 anti-reflective film-attached transparent substrates prepared under the same conditions were prepared and tested. For example, in the case of Example 1, 16 anti-reflective film-attached transparent substrates were prepared under the conditions in Example 1 and by slightly changing the thickness of each layer from the conditions in Example 1, a black tape “KUKKIRI MIERU” manufactured by TOMOEGAWA CORPORATION) was attached to the main surface (the other main surface) not having the diffusion layer and the anti-reflective film, and then these anti-reflective film-attached transparent substrates were arranged (tiled) in a matrix of 4 pieces vertically and 4 pieces horizontally with no gaps. The color deviation of the anti-reflective film-attached transparent substrate after tiling was visually evaluated according to the following criteria. Other examples were also tested in the same manner. The evaluation results are shown in Table 1.

Good: when a white LED illumination glares on the main surface (one main surface) of the anti-reflective film-attached transparent substrate having the diffusion layer and the anti-reflective film and the main surface is viewed from various angles, the white illumination glared on the anti-reflective film-attached transparent substrate appears achromatic to yellowish green only, and the difference in color between substrates is not noticeable. In addition, when viewed from the front, the anti-reflective film-attached transparent substrate has a strong sense of black, providing a good quality as a surface material for a display.

Poor: when a white LED illumination glares on the main surface (one main surface) of the anti-reflective film-attached transparent substrate having the diffusion layer and the anti-reflective film and the main surface is viewed from various angles, the white illumination glared on the anti-reflective film-attached transparent substrate appears as various colors such as achromatic, red, blue, and green, and the difference in color between substrates is noticeable.

### Example 1

A diffusion layer and an anti-reflective film were formed in this order on one main surface of a transparent substrate by the following method, to prepare an anti-reflective film-attached transparent substrate. Note that, as the transparent substrate, a resin substrate on a glass substrate was used, as to be described later.

### (Formation of Diffusion Layer)

An anti-glare PET film (manufactured by REIKO Co., Ltd., Sa: 0.259 μm, Sdr: 0.0620, Sdq: 0.361, Spc: 1703 (1/mm)), haze value: 60%) as a laminate (resin film+anti-glare layer) was attached to one main surface of a chemically strengthened glass substrate (50 mm in length×50 mm in width×1.1 mm in thickness, Dragontrail (Registered trademark) manufactured by AGC Inc.) by using an acrylic adhesive (transparent adhesive), to provide a diffusion layer on a transparent substrate. Note that, the Sa, Sdr, Sdq, and Spc here are values measured in a state where no anti-reflective film is formed on the diffusion layer. The Sa, Sdr, Sdq, and Spc of the anti-reflective film-attached transparent substrate after the anti-reflective film is formed also show little change from the above values and are considered to be within the above preferred ranges.

### (Formation of Barrier Layer)

Next, a SiN layer having a thickness shown in Table 1 was formed as a barrier layer on the diffusion layer. For example, in Example 1, the barrier layer had a thickness of 15 nm.

As the barrier layer, a silicon target was used in a digital sputtering method, the pressure was kept at 0.2 Pa with an argon gas, pulse sputtering was performed under conditions of a frequency of 100 kHz, a power density of 10.0 W/cm², and a reverse pulse width of 3 μsec to form a silicon film having a minute thickness, and immediately thereafter, nitridation with a nitrogen gas was performed, which was repeated at a high speed to form a silicon nitride film, and a layer made of a silicon nitride (SiNₓ) having a predetermined thickness was formed. Here, a nitrogen flow rate during the nitridation with a nitrogen gas was 800 sccm, and an input power of a nitridation source was 600 W.

### (Formation of Anti-Reflective Film)

Next, a NMWO layer (high refractive index layer) and a SiO layer (low refractive index layer) were alternately formed on the barrier layer to form an anti-reflective film having the film configuration shown in Table 1. Note that, the NMWO layer means a mixed oxide layer containing Nb, Mo, and W. For example, the film configuration of the anti-reflective film in Example 1 in Table 1 means that a 4 nm NMWO layer was formed on the barrier layer, then a 33 nm SiO layer was formed, then a 110 nm NMWO layer was formed, and then a 81 nm SiO layer was formed, to form an anti-reflective film having a film configuration of four layers. The film-forming methods for the SiO layer and the NMWO layer are as follows.

### (Formation of NMWO Layer)

In a digital sputtering method, a target obtained by mixing and sintering niobium, molybdenum, and tungsten in a weight ratio of 45:30:25 was used, the pressure was kept at 0.2 Pa with an argon gas, pulse sputtering was performed under conditions of a frequency of 100 kHz, a power density of 10.0 W/cm², and a reverse pulse width of 3 μsec to form a metal film having a minute thickness, and immediately thereafter, oxidation with an oxygen gas was performed, which was repeated at a high speed to form an oxide film, so as to form a NMWO layer having a predetermined thickness. Note that, when the composition of the NMWO layer formed by this method was measured by X-ray photoelectron spectroscopy (XPS) depth direction composition analysis using argon ion sputtering, excluding oxygen, Nb was 51.9 at %, Mo was 33.5 at %, W was 14.6 at %, and the content of group B elements was 45 wt %.

### (Formation of SiO Layer)

A silicon target was used in a digital sputtering method, the pressure was kept at 0.2 Pa with an argon gas, pulse sputtering was performed under conditions of a frequency of 100 kHz, a power density of 10.0 W/cm², and a reverse pulse width of 3 usec to form a silicon film having a minute thickness, and immediately thereafter, oxidation with an oxygen gas was performed, which was repeated at a high speed to form a silicon oxide film, and a layer made of a silicon oxide [silica (SiOₓ)] having a predetermined thickness was formed. Here, an oxygen flow rate during the oxidation with an oxygen gas was 500 sccm, and an input power of an oxidation source was 1000 W.

### (Formation of Antifouling Film)

KY-185 (trade name, manufactured by Shin-Etsu Chemical Co., Ltd.) as a fluorine-containing organosilicon compound was charged into a metal crucible (evaporation source) and heated to evaporate at 230° C. to 350° C. The evaporated particles evaporated and diffused into a vacuum chamber in which the substrate was installed, and adhered on the surface of the substrate. A 4-nm thick antifouling film was formed while a vapor deposition rate was monitored by controlling with a crystal oscillator.

### Example 2

An anti-reflective film-attached transparent substrate was obtained in the same manner as in Example 1 except that the film configuration of the anti-reflective film was changed as shown in Table 1 and an anti-reflective film having a film configuration of six layers was formed.

### Example 3

An anti-reflective film-attached transparent substrate was obtained in the same manner as in Example 1 except that the film configuration of the anti-reflective film was changed as shown in Table 1, the film-forming method for the NMWO layer was changed as follows, and an anti-reflective film having a film configuration of six layers was formed.

### (Formation of NMWO Layer)

In a digital sputtering method, a target obtained by mixing and sintering niobium, molybdenum, and tungsten in a weight ratio of 24:30:46 was used, the pressure was kept at 0.2 Pa with an argon gas, pulse sputtering was performed under conditions of a frequency of 100 kHz, a power density of 10.0 W/cm², and a reverse pulse width of 3 μsec to form a metal film having a minute thickness, and immediately thereafter, oxidation with an oxygen gas was performed, which was repeated at a high speed to form an oxide film, so as to form a NMWO layer having a predetermined thickness. The transmittance of the anti-reflective film was adjusted by adjusting the degree of oxidation of the NMWO layer. Note that, when the composition of the NMWO layer formed by this method was measured by X-ray photoelectron spectroscopy (XPS) depth direction composition analysis using argon ion sputtering, excluding oxygen, Nb was 31.5 at %, Mo was 38.1 at %, W was 30.5 at %, and the content of group B elements was 24 wt %.

### Example 4

An anti-reflective film-attached transparent substrate was obtained in the same manner as in Example 3 except that the film configuration of the anti-reflective film was changed as shown in Table 1, the degree of oxidation of the high refractive index material was adjusted such that the luminous transmittance Y of the anti-reflective film-attached transparent substrate was 55%, and an anti-reflective film having a film configuration of four layers was formed.

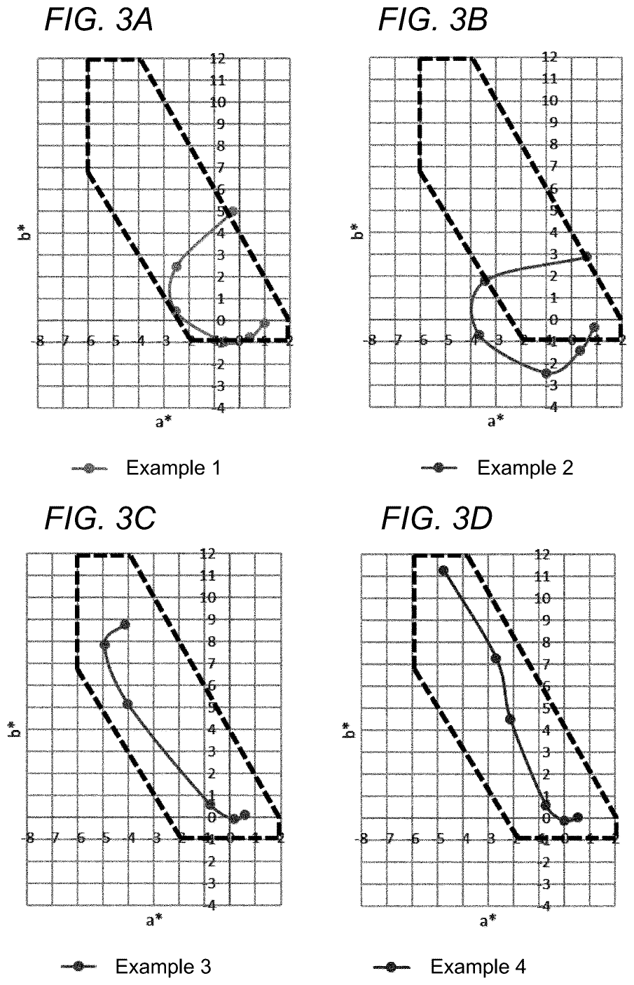

The anti-reflective film-attached transparent substrate obtained in each example was subjected to the above evaluation. The results are shown in Table 1. FIG. 3A to FIG. 3D show the a* and the b* measured for each diffusely reflected light. FIG. 3A to FIG. 3D are diagrams showing the a* and the b* of the diffusely reflected lights at respective angles in Examples 1 to 4, respectively. In each diagram, when a plot is located within a region indicated by the dotted line, it means that all of the formulas (1) to (4) are satisfied.

TABLE 1

| | | | Example 1 | Example 2 | Example 3 | Example 4 |
|---|---|---|---|---|---|---|
| Number of layers in anti-reflective film | | | 4 | 6 | 6 | 4 |
| Luminous transmittance Y (D65) (%) | | | 75 | 75 | 75 | 55 |
| b* of transmission color under | | | 1.1 | 1.8 | 0.5 | 0.4 |
| D65 light source | | | | | | |
| Transmitted haze (%) | | | 60 | 60 | 60 | 60 |
| High refractive index layer | | | NMWO | NMWO | NMWO | NMWO |
| Diffusion reflection color | | | Green, blue, | Green and blue | Yellowish green | Yellowish green |
| | | | and red | | | |
| Antifouling film | | KY-185 (nm) | 4 | 4 | 4 | 4 |
| Anti- | 6 | Low refractive | — | 80 | 64 | — |
| reflective | | index layer (nm) | | | | |
| film | 5 | High refractive | — | 39 | 4 | — |
| | | index layer (nm) | | | | |
| | 4 | Low refractive | 81 | 5 | 13 | 78 |
| | | index layer (nm) | | | | |
| | 3 | High refractive | 110 | 60 | 110 | 113 |
| | | index layer (nm) | | | | |
| | 2 | Low refractive | 33 | 29 | 31 | 24 |
| | | index layer (nm) | | | | |
| | 1 | High refractive | 4 | 5 | 5 | 7 |
| | | index layer (nm) | | | | |

| barrier layer | SiN (nm) | 15 | | | 15 | | | 15 | | | 15 | | |
|---|---|---|---|---|---|---|---|---|---|---|---|---|---|
| Substrate | | Anti-glare PET | | | Anti-glare PET | | | Anti-glare PET | | | Anti-glare PET | | |
| | | film/transparent | | | film/transparent | | | film/transparent | | | film/transparent | | |
| | | adhesive/glass | | | adhesive/glass | | | adhesive/glass | | | adhesive/glass | | |
| Diffusion | Angle with respect | L* | a* | b* | L* | a* | b* | L* | a* | b* | L* | a* | b* |
| reflection | to specularly | | | | | | | | | | | | |
| color (D65) | reflected light | | | | | | | | | | | | |
| | −15° | 50.2 | −0.3 | 5.0 | 52.1 | 0.6 | 2.9 | 51.8 | −4.2 | 8.8 | 52.0 | −4.8 | 11.3 |
| | 15° | 23.3 | −2.5 | 2.5 | 25.0 | −3.5 | 1.8 | 23.5 | −5.0 | 7.9 | 23.7 | −2.7 | 7.3 |
| | 25° | 10.0 | −2.5 | 0.4 | 11.5 | −3.7 | −0.7 | 11.1 | −4.0 | 5.2 | 11.2 | −2.1 | 4.5 |
| | 45° | 2.2 | −0.6 | −1.0 | 2.6 | −1.0 | −2.5 | 2.2 | −0.8 | 0.6 | 2.1 | −0.7 | 0.6 |
| | 75° | 0.9 | 0.4 | −0.8 | 0.9 | 0.3 | −1.4 | 0.7 | 0.1 | −0.1 | 0.6 | 0.0 | −0.1 |
| | 110° | 1.2 | 1.0 | −0.1 | 1.0 | 0.9 | −0.4 | 0.8 | 0.6 | 0.2 | 0.7 | 0.5 | 0.1 |

| | | | | |
|---|---|---|---|---|
| Color deviation evaluation | Poor | Poor | Good | Good |

As seen from the results in Table 1, in Example 3 and Example 4 as Inventive Examples, the a* and the b″ measured for each diffusely reflected light satisfy all of the formulas (1) to (4), so that it is possible to prevent a color variation after tiling.

As described above, the following matters are disclosed in the present description.

1. An anti-reflective film-attached transparent substrate including:
a transparent substrate having two main surfaces; and
a diffusion layer and an anti-reflective film in this order from a transparent substrate side on one main surface of the transparent substrate, in which
when reflection on the other main surface of the transparent substrate is eliminated and a light source is incident on the one main surface at an incident angle of 45°, a* and b* of diffusely reflected lights at angles of −15°, 15°, 25°, 45°, 75°, and 110° with respect to a specularly reflected light under a D65 light source satisfy the following formulas (1) to (4).

$$- 6 \leq {a}^{*} \leq 2 \qquad ( 1 )$$

$$- 1 \leq {b}^{*} \leq 12 \qquad ( 2 )$$

$${b}^{*} \leq - 2 {a}^{*} + 4 \qquad ( 3 )$$

$${b}^{*} \geq - 2 {a}^{*} - 5 \qquad ( 4 )$$

2. The anti-reflective film-attached transparent substrate according to the above 1, having a haze value of 30% or more.

3. The anti-reflective film-attached transparent substrate according to the above 1 or 2, in which L* of the diffusely reflected light at −15° is 30 to 60, L* of the diffusely reflected light at 15° is 15 to 35, and L* of the diffusely reflected light at 25° is 5 to 20 under a D65 light source.

4. The anti-reflective film-attached transparent substrate according to any one of the above 1 to 3, having a luminous transmittance (Y) of 20% to 90%.

5. The anti-reflective film-attached transparent substrate according to any one of the above 1 to 4, in which the anti-reflective film has a sheet resistance of 10⁴Ω/□ or more.

6. The anti-reflective film-attached transparent substrate according to any one of the above 1 to 5, in which b* of a transmission color under a D65 light source is 5 or less.

7. The anti-reflective film-attached transparent substrate according to any one of the above 1 to 6, in which the anti-reflective film has a laminated structure in which at least two dielectric layers having different refractive indices are laminated, at least one of the dielectric layers is mainly formed of a Si oxide, at least another layer among layers in the laminated structure is mainly formed of a mixed oxide of an oxide containing at least one selected from the group A consisting of Mo and W and an oxide containing at least one selected from the group B consisting of Si, Nb, Ti, Zr, Ta, Al, Sn, and In, and a content of elements of the group B contained in the mixed oxide is 65 mass % or less with respect to a total of elements of the group A contained in the mixed oxide and the elements of the group B contained in the mixed oxide.

8. The anti-reflective film-attached transparent substrate according to any one of the above 1 to 7, further including an antifouling film on the anti-reflective film.

9. The anti-reflective film-attached transparent substrate according to any one of the above 1 to 8, in which the transparent substrate includes a glass.

10. The anti-reflective film-attached transparent substrate according to any one of the above 1 to 9, in which the transparent substrate includes at least one resin selected from polyethylene terephthalate, a polycarbonate, acrylic, silicone, and triacetyl cellulose.

11. The anti-reflective film-attached transparent substrate according to any one of the above 1 to 10, in which the transparent substrate is a laminate including a glass and at least one resin selected from polyethylene terephthalate, a polycarbonate, acrylic, silicone, and triacetyl cellulose.

12. The anti-reflective film-attached transparent substrate according to the above 9 or 11, in which the glass is chemically strengthened.

13. An image display device including the anti-reflective film-attached transparent substrate according to any one of the above 1 to 12.

Although the present invention has been described in detail with reference to specific embodiments, it is apparent to those skilled in the art that various changes and modifications can be made without departing from the spirit and scope of the present invention. The present application is based on a Japanese Patent Application (No. 2022-064752) filed on Apr. 8, 2022, the contents of which are incorporated herein by reference.

### REFERENCE SIGNS LIST

1 anti-reflective film-attached transparent substrate
10 transparent substrate
11 one main surface
12 the other main surface
20 black tape
30 anti-reflective film
31 diffusion layer
32 first dielectric layer
34 second dielectric layer
50 light source
60 incident light
61 specularly reflected light
71, 72, 73, 74, 75, 76 diffusely reflected light

1. An anti-reflective film-attached transparent substrate comprising:
a transparent substrate comprising two main surfaces; and
a diffusion layer and an anti-reflective film in this order from a transparent substrate side on one main surface of the transparent substrate,
wherein when reflection on the other main surface of the transparent substrate is eliminated and a light source is incident on the one main surface at an incident angle of 45°, a* and b* of diffusely reflected lights at angles of −15°, 15°, 25°, 45°, 75°, and 110° with respect to a specularly reflected light under a D65 light source satisfy the following formulas (1) to (4):
$$- 6 \leq {a}^{*} \leq 2 \qquad ( 1 )$$
$$- 1 \leq {b}^{*} \leq 12 \qquad ( 2 )$$
$${b}^{*} \leq - 2 {a}^{*} + 4 \qquad ( 3 )$$
$${b}^{*} \geq - 2 {a}^{*} - 5 \qquad ( 4 )$$

2. The anti-reflective film-attached transparent substrate according to claim 1, having a haze value of 30% or more.

3. The anti-reflective film-attached transparent substrate according to claim 1, wherein L* of the diffusely reflected light at −15° is 30 to 60, L* of the diffusely reflected light at 15° is 15 to 35, and L* of the diffusely reflected light at 25° is 5 to 20 under a D65 light source.

4. The anti-reflective film-attached transparent substrate according to claim 1, having a luminous transmittance (Y) of 20% to 90%.

5. The anti-reflective film-attached transparent substrate according to claim 1, wherein the anti-reflective film has a sheet resistance of 10⁴Ω/□ or more.

6. The anti-reflective film-attached transparent substrate according to claim 1, wherein b* of a transmission color under a D65 light source is 5 or less.

7. The anti-reflective film-attached transparent substrate according to claim 1, wherein the anti-reflective film has a laminated structure in which at least two dielectric layers having different refractive indices are laminated, at least one of the dielectric layers is mainly formed of a Si oxide, at least another layer among layers in the laminated structure is mainly formed of a mixed oxide of an oxide containing at least one selected from the group A consisting of Mo and W and an oxide containing at least one selected from the group B consisting of Si, Nb, Ti, Zr, Ta, Al, Sn, and In, and a content of elements of the group B contained in the mixed oxide is 65 mass % or less with respect to a total of elements of the group A contained in the mixed oxide and the elements of the group B contained in the mixed oxide.

8. The anti-reflective film-attached transparent substrate according to claim 1, further comprising an antifouling film on the anti-reflective film.

9. The anti-reflective film-attached transparent substrate according to claim 1, wherein the transparent substrate comprises a glass.

10. The anti-reflective film-attached transparent substrate according to claim 1, wherein the transparent substrate comprises at least one resin selected from polyethylene terephthalate, a polycarbonate, acrylic, silicone, and triacetyl cellulose.

11. The anti-reflective film-attached transparent substrate according to claim 1, wherein the transparent substrate is a laminate comprising a glass and at least one resin selected from polyethylene terephthalate, a polycarbonate, acrylic, silicone, and triacetyl cellulose.

12. The anti-reflective film-attached transparent substrate according to claim 11, wherein the glass is chemically strengthened.

13. An image display device comprising the anti-reflective film-attached transparent substrate according to claim 1.
